(19) United States
(12) Patent Application Publication
(10) Pub. No.: US 2026/0276952 A1
(43) Pub. Date: Sep. 17, 2026

(54) OPTICAL IMAGING SYSTEM

(71) Applicant: Samsung Electro-Mechanics Co., Ltd., Suwon-si (KR)

(72) Inventors: Ju Hwa SON, Suwon-si (KR); Hyuk Joo KIM, Suwon-si (KR); Yong Joo JO, Suwon-si (KR); Kyu Min CHAE, Suwon-si (KR)

(73) Assignee: Samsung Electro-Mechanics Co., Ltd., Suwon-si (KR)

(21) Appl. No.: 19/464,847

(22) Filed: Jan. 30, 2026

(30) Foreign Application Priority Data
Mar. 14, 2025 (KR) 10-2025-0033563

(51) Int. Cl. G02B 13/00; G02B 9/64

(52) U.S. Cl. CPC G02B 13/0045; G02B 9/64

(57) ABSTRACT

An optical imaging system includes a first lens having a negative refractive power, a second lens, a third lens having a positive refractive power, a fourth lens, a fifth lens, a sixth lens, a seventh lens having a negative refractive power, and an eighth lens, the first lens, the second lens, the third lens, the fourth lens, the fifth lens, the sixth lens, the seventh lens, and the eighth lens being sequentially arranged in ascending numerical order along an optical axis of the optical imaging system from an object side of the optical imaging system toward an imaging plane of the optical imaging system, wherein the optical imaging system satisfies a conditional expression 2.5<TTL/f<3.5, where TTL is a distance along the optical axis from an object-side surface of the first lens to the imaging plane, and f is a focal length of the optical imaging system.

### CROSS-REFERENCE TO RELATED APPLICATIONS

This application claims the benefit under 35 USC 119(a) of Korean Patent Application No. 10-2025-0033563 filed on Mar. 14, 2025, in the Korean Intellectual Property Office, the entire disclosure of which is incorporated herein by reference for all purposes.

### BACKGROUND

### 1. Field

The present disclosure relates to an optical imaging system.

### 2. Description of Background

Recently, camera modules have been adopted in various devices and facilities, for example, in mobile devices, vehicles, and industrial automation environments. For image-based automated inspection and analysis, optical systems need to be capable of clearly identifying even close-range areas.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having a negative refractive power, a second lens having a refractive power, a third lens having a positive refractive power, a fourth lens having a refractive power, a fifth lens having a refractive power, a sixth lens having a refractive power, a seventh lens having a negative refractive power, and an eighth lens having a refractive power, the first lens, the second lens, the third lens, the fourth lens, the fifth lens, the sixth lens, the seventh lens, and the eighth lens being sequentially arranged in ascending numerical order along an optical axis of the optical imaging system from an object side of the optical imaging system toward an imaging plane of the optical imaging system, wherein the optical imaging system satisfies a conditional expression 2.5<TTL/f<3.5, where TTL is a distance along the optical axis from an object-side surface of the first lens to the imaging plane, and f is a focal length of the optical imaging system.

The second lens may have a concave object-side surface in a paraxial region thereof.

The second lens may have a convex image-side surface in a paraxial region thereof.

The sixth lens may have a convex image-side surface in a paraxial region thereof.

The optical imaging system may satisfy a conditional expression 1<CT2/CT8<3, where CT2 is a thickness of the second lens along the optical axis, and CT8 is a thickness of the eighth lens along the optical axis.

The optical imaging system may satisfy a conditional expression 0<f3/f4<5, where f3 is a focal length of the third lens, and f4 is a focal length of the fourth lens.

The optical imaging system may satisfy a conditional expression −2<f4/f5<0, where f4 is a focal length of the fourth lens, and f5 is a focal length of the fifth lens.

The second lens and the sixth lens may each have a positive refractive power.

The second lens may have a negative refractive power, and the sixth lens may have a positive refractive power.

The fourth lens may have a positive refractive power, and the fifth lens may have a negative refractive power.

The second lens or the sixth lens may have a greatest thickness along the optical axis among the first lens to the eighth lens.

In another general aspect, an optical imaging system includes a first lens, a second lens, a third lens, a fourth lens, a fifth lens, a sixth lens, a seventh lens, and an eighth lens sequentially arranged in ascending numerical order along an optical axis of the optical imaging system from an object side of the optical imaging system toward an imaging plane of the optical imaging system, wherein the second lens or the sixth lens has a greatest thickness along the optical axis among the first lens to the eighth lens, and the optical imaging system satisfies a conditional expression 2.5<TTL/f<3.5, where TTL is a distance along the optical axis from an object-side surface of the first lens to the imaging plane, and f is a focal length of the optical imaging system.

The optical imaging system may satisfy a conditional expression 1.5≤TTL/(2*ImgHT)<2.0, where 2*ImgHT is a diagonal length of the imaging plane.

The optical imaging system may satisfy a conditional expression 1<CT2/CT8<3, where CT2 is a thickness of the second lens along the optical axis, and CT8 is a thickness of the eighth lens along the optical axis.

The optical imaging system may further include a stop disposed between the second lens and the third lens.

The third lens and the fourth lens may each have a positive refractive power, and the seventh lens may have a negative refractive power.

Any one or any combination of any two or more of the second lens, the fifth lens, and the seventh lens may have a greatest refractive index among the first lens to the eighth lens.

Other features and aspects will be apparent from the following detailed description, the drawings, and the claims.

### BRIEF DESCRIPTION OF DRAWINGS

FIG. 1 is a diagram illustrating a configuration of an optical imaging system according to a first embodiment of the present disclosure.

FIG. 2 is graphs illustrating aberration characteristics of the optical imaging system illustrated in FIG. 1.

FIG. 3 is a diagram illustrating a configuration of an optical imaging system according to a second embodiment of the present disclosure.

FIG. 4 is graphs illustrating aberration characteristics of the optical imaging system illustrated in FIG. 3.

FIG. 5 is a diagram illustrating a configuration of an optical imaging system according to a third embodiment of the present disclosure.

FIG. 6 is graphs illustrating aberration characteristics of the optical imaging system illustrated in FIG. 5.

FIG. 7 is a diagram illustrating a configuration of an optical imaging system according to a fourth embodiment of the present disclosure.

FIG. 8 is graphs illustrating aberration characteristics of the optical imaging system illustrated in FIG. 7.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, a thickness, a size, and a shape of a lens may be exaggerated for clarity of illustration, and an aspherical shape of a lens is merely an example and is not limited thereto.

In this specification, the numbering of lenses may refer to the order in which the lenses are arranged along an optical axis of an optical imaging system from an object side of the optical imaging system. For example, a first lens refers to a lens closest to an object, and a second lens refers to a lens second closest to the object.

In addition, in a description of a shape of a lens, a statement that a surface of a lens is convex means that a paraxial region of the surface is convex, and a statement that a surface of a lens is concave means that a paraxial region of the surface is concave. Accordingly, even when it is stated that a surface of a lens is convex, an edge portion of the surface of the lens may be concave. Similarly, even when it is stated that a surface of a lens is concave, an edge portion of the surface of the lens may be convex.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

In this specification, all length-related parameters, including a radius of curvature, a thickness, an effective radius, and a focal length of a lens and a distance between lenses are expressed in millimeters, and a field of view is expressed in degrees (°).

The optical imaging system according to embodiments of the present disclosure may be employed in industrial robots, for example, camera modules used in machine vision (MV), and may also be utilized in various fields requiring the performance of the embodiments.

The optical imaging system according to embodiments of the present disclosure may include eight lenses. For example, the optical imaging system may include a first lens, a second lens, a third lens, a fourth lens, a fifth lens, a sixth lens, a seventh lens, and an eighth lens sequentially arranged in ascending numerical order along an optical axis of the optical imaging system from an object side of the optical imaging system toward an imaging plane of the optical imaging system.

According to embodiments of the present disclosure, all eight lenses may be plastic lenses. For example, the specific materials and properties of the individual lenses may vary.

According to embodiments of the present disclosure, the eight lenses may have aspherical surfaces. The aspherical surfaces of the lenses may be expressed by Equation 1 below:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system according to embodiments of the present disclosure may satisfy any one or any combination of any two or more of the following Conditional Expressions 1 to 7:

$$1.5 \leq TTL / ( 2 * ImgHT ) < 2. \qquad ( Conditional Expression 1 )$$

$$1.5 < TTL / f < 3.5 \qquad ( Conditional Expression 2 )$$

$$0 < f 3 / f 4 < 5 \qquad ( Conditional Expression 3 )$$

$$- 2 < f 4 / f 5 < 0 \qquad ( Conditional Expression 4 )$$

$$1 < CT 2 / CT 8 < 3 \qquad ( Conditional Expression 5 )$$

$$10 < v 1 - v 2 < 40 \qquad ( Conditional Expression 6 )$$

$$Fno \leq 2. \qquad ( Conditional Expression 7 )$$

In Conditional Expression 1, TTL is a distance along the optical axis from an object-side surface of the first lens to an imaging plane of the optical imaging system, and ImgHT is one half of a diagonal length of the imaging plane. Conditional Expression 1 represents a slim factor of the optical imaging system. A smaller value facilitates miniaturization; and thus, optical imaging systems for mobile devices generally have a slim factor less than 1. However, since the optical imaging system according to embodiments of the present disclosure is intended for application to industrial robots, the optical imaging system may have a relatively large slim factor value.

In Conditional Expression 2, TTL is the distance along the optical axis from the object-side surface of the first lens to the imaging plane, and f is a focal length of the optical imaging system. Conditional Expression 2 represents the optical characteristics of the optical imaging system. For example, a longer focal length (e.g., a telephoto camera) has a smaller value. Since the optical imaging system according to embodiments of the present disclosure is a wide-angle camera and is less subject to size constraints due to the nature of its application, the optical imaging system may have a value within the range specified in Conditional Expression 2.

In Conditional Expression 3, f3 is a focal length of the third lens, and f4 is a focal length of the fourth lens. According to embodiments of the present disclosure, spherical aberration may be minimized by sequentially arranging third and fourth lenses each having a positive refractive power. Furthermore, sensitivity may be improved by setting the refractive powers of two adjacent lenses to be similar.

In Conditional Expression 4, f4 is a focal length of the fourth lens, and f5 is a focal length of the fifth lens. According to embodiments of the present disclosure, sensitivity may also be improved by setting the refractive powers of two adjacent lenses to be similar.

In Conditional Expression 5, CT2 is an on-axis thickness of the second lens, and CT8 is an on-axis thickness of the eighth lens. Conditional Expression 5 relates to the large thickness of the second lens in embodiments of the present disclosure. According to embodiments of the present disclosure, the second lens may be manufactured to have a relatively large on-axis thickness. When the second lens is manufactured to be thick, the angular difference in the path of light from the object-side surface of the second lens to the image-side surface of the second lens may be reduced, which may be advantageous for compensating for a modulation transfer function (MTF) not only when the object distance is close, but also when the object distance is set to infinity.

In Conditional Expression 6, v1 is an Abbe number of the first lens, and v2 is an Abbe number of the second lens. When Conditional Expression 6 is satisfied, chromatic aberration of the optical imaging system may be minimized.

Conditional Expression 7 relates to a brightness performance of the optical imaging system according to embodiments of the present disclosure.

Hereinafter, embodiments of the present disclosure will be described in detail.

### First Embodiment

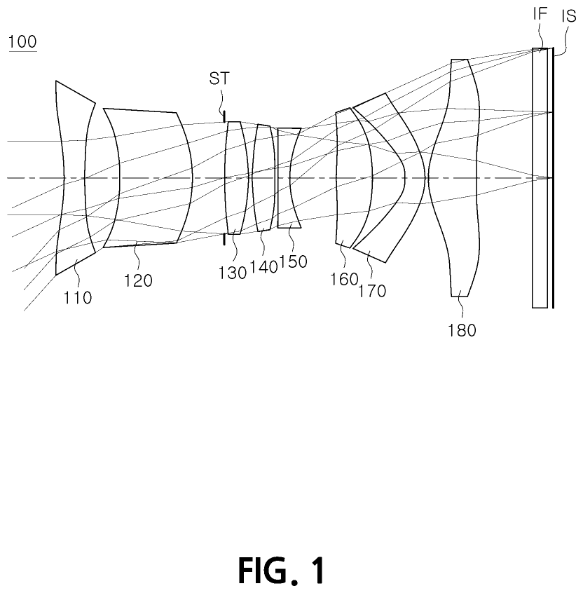

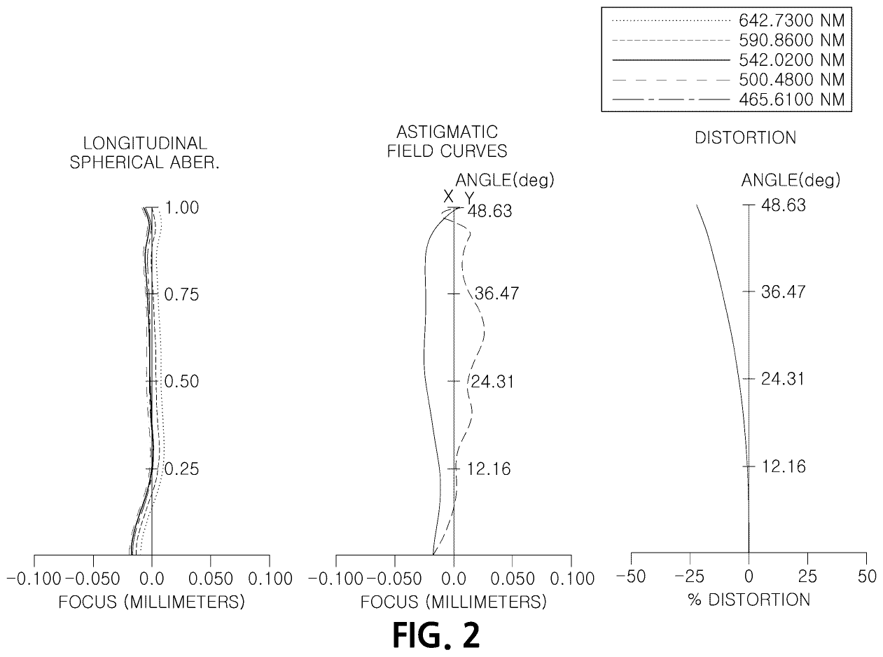

FIG. 1 is a diagram illustrating a configuration of an optical imaging system according to a first embodiment of the present disclosure, and FIG. 2 is graphs illustrating aberration characteristics of the optical imaging system illustrated in FIG. 1.

An optical imaging system 100 according to the first embodiment of the present disclosure may include a first lens 110, a second lens 120, a third lens 130, a fourth lens 140, a fifth lens 150, a sixth lens 160, a seventh lens 170, and an eighth lens 180 sequentially arranged in ascending numerical order along an optical axis of the optical imaging system 100 from an object side of the optical imaging system 100 toward an imaging plane of the optical imaging system 100.

The first lens 110 may have a negative refractive power. A focal length f1 of the first lens 110 may be −13.1179 mm. The first lens 110 may have a concave object-side surface in a paraxial region thereof, and a concave image-side surface in a paraxial region thereof. An Abbe number of the first lens 110 may be greater than 50.

The second lens 120 may have a positive refractive power. A focal length f2 of the second lens 120 may be 17.5739 mm. The second lens 120 may have a concave object-side surface in a paraxial region thereof, and a convex image-side surface in a paraxial region thereof. An Abbe number of the second lens 120 may be less than the Abbe number of the first lens 110, and may be greater than 30.

The third lens 130 may have a positive refractive power. A focal length f3 of the third lens 130 may be 13.2473 mm. The third lens 130 may have a convex object-side surface in a paraxial region thereof, and a convex image-side surface in a paraxial region thereof. An Abbe number of the third lens 130 may be greater than 50.

The fourth lens 140 may have a positive refractive power. A focal length f4 of the fourth lens 140 may be 11.6178 mm. The fourth lens 140 may have a convex object-side surface in a paraxial region thereof, and a convex image-side surface in a paraxial region thereof. An Abbe number of the fourth lens 140 may be greater than 50.

The fifth lens 150 may have a negative refractive power. A focal length f5 of the fifth lens 150 may be −7.9096 mm. The fifth lens 150 may have a concave object-side surface in a paraxial region thereof, and a concave image-side surface in a paraxial region thereof. An Abbe number of the fifth lens 150 may be less than 30.

The sixth lens 160 may have a positive refractive power. A focal length f6 of the sixth lens 160 may be 11.3600 mm. The sixth lens 160 may have a convex object-side surface in a paraxial region thereof, and a convex image-side surface in a paraxial region thereof. An Abbe number of the sixth lens 160 may be greater than 50.

The seventh lens 170 may have a negative refractive power. A focal length f7 of the seventh lens 170 may be −5.6726 mm. The seventh lens 170 may have a concave object-side surface in a paraxial region thereof, and a convex image-side surface in a paraxial region thereof. An Abbe number of the seventh lens 170 may be less than 30.

The eighth lens 180 may have a positive refractive power. A focal length f8 of the eighth lens 180 may be 6.3748 mm. The eighth lens 180 may have a convex object-side surface in a paraxial region thereof, and a concave image-side surface in a paraxial region thereof. An Abbe number of the eighth lens 180 may be greater than 50.

The optical imaging system 100 according to the first embodiment of the present disclosure may include a stop ST disposed between the second lens 120 and the third lens 130, and an optical filter IF and an image sensor IS disposed on an image side of the eighth lens 180. The imaging plane of the optical imaging system 100 may be formed on the image sensor IS.

The characteristics of each element of the optical imaging system 100 according to the first embodiment of the present disclosure are illustrated in Table 1 below.

TABLE 1

| | | | Thick- | Refrac- | | |
|---|---|---|---|---|---|---|
| Surface | | Radius of | ness/ | tive | Abbe | Effective |
| No. | Element | Curvature | Distance | Index | Number | Radius |
| Object | | Infinity | Infinity | | | |
| S1 | | Infinity | 0.350 | | | |
| S2 | First | −10.5732 | 0.9508 | 1.538 | 55.76 | 4.600 |
| S3 | Lens | 21.8483 | 1.6266 | | | 3.523 |
| S4 | Second | −10.0992 | 3.3847 | 1.571 | 37.35 | 3.282 |
| S5 | Lens | −5.6491 | 1.4804 | | | 3.061 |
| S6 | Stop | Infinity | 0.0200 | | | 2.630 |
| S7 | Third | 87.5396 | 1.0894 | 1.538 | 55.76 | 2.643 |
| S8 | Lens | −7.7194 | 0.1661 | | | 2.642 |
| S9 | Fourth | 8.0153 | 1.0604 | 1.538 | 55.76 | 2.533 |
| S10 | Lens | −26.9919 | 0.1612 | | | 2.448 |
| S11 | Fifth | −46.0299 | 0.5431 | 1.621 | 25.94 | 2.349 |
| S12 | Lens | 5.5235 | 2.1404 | | | 2.355 |
| S13 | Sixth | 21.2965 | 1.6791 | 1.538 | 55.76 | 3.073 |
| S14 | Lens | −8.3275 | 1.5141 | | | 3.296 |
| S15 | Seventh | −1.3248 | 0.9211 | 1.621 | 25.94 | 3.319 |
| S16 | Lens | −2.6889 | 0.1502 | | | 4.003 |
| S17 | Eighth | 3.1824 | 2.2295 | 1.538 | 55.76 | 5.393 |
| S18 | Lens | 33.6201 | 2.6000 | | | 5.594 |
| S19 | Filter | Infinity | 0.7100 | 1.519 | 64.17 | 6.050 |
| S20 | | Infinity | 0.0582 | | | 6.120 |
| S21 | Imaging | Infinity | | | | 6.130 |
| | Plane | | | | | |

Referring to Table 1, the second lens 120 may be the thickest lens among the first lens 110 to the eighth lens 180, and the fifth lens 150 and the seventh lens 170 may be high refractive index lenses each having a refractive index of 1.6 or higher.

Aspherical coefficients of each lens of the optical imaging system 100 according to the first embodiment of the present disclosure are illustrated in Table 2 below.

TABLE 2

| Value | S2 | S3 | S4 | S5 | S7 | S8 | S9 | S10 |
|---|---|---|---|---|---|---|---|---|
| K | 0.8169 | −0.0313 | 1.9721 | 0.4172 | 0.0328 | −1.5631 | −0.4160 | 2.4999 |
| A | 2.086E−03 | 8.101E−04 | −2.605E−03 | 2.433E−03 | 5.358E−03 | 2.210E−03 | −6.360E−03 | −7.132E−04 |
| B | 2.886E−05 | 2.576E−04 | 1.586E−04 | −1.047E−04 | −5.489E−04 | −1.517E−04 | 9.413E−04 | −2.717E−03 |
| C | −1.814E−05 | −9.470E−05 | −2.525E−05 | 2.346E−05 | −1.802E−05 | −7.433E−05 | −4.686E−04 | 9.656E−04 |
| D | 2.491E−06 | 2.369E−05 | 8.070E−06 | −4.232E−06 | 1.934E−05 | 3.675E−05 | 2.169E−04 | −1.540E−04 |
| E | −1.203E−07 | −3.847E−06 | −1.839E−06 | 5.486E−07 | −4.128E−06 | −8.299E−06 | −4.548E−05 | 2.882E−07 |
| F | −1.185E−08 | 4.088E−07 | 2.689E−07 | −4.226E−08 | 4.085E−07 | 1.027E−06 | −8.709E−07 | 4.619E−06 |
| G | 2.465E−09 | −2.802E−08 | −2.515E−08 | 1.780E−09 | −1.543E−08 | −6.413E−08 | 2.773E−06 | −8.437E−07 |
| H | −1.980E−10 | 1.182E−09 | 1.464E−09 | −3.147E−11 | 0.00E+00 | 1.550E−09 | −6.709E−07 | 6.614E−08 |
| J | 9.110E−12 | −2.756E−11 | −4.829E−11 | 0.00E+00 | 0.00E+00 | 0.00E+00 | 7.854E−08 | −1.983E−09 |
| L | −2.498E−13 | 2.678E−13 | 6.892E−13 | 0.00E+00 | 0.00E+00 | 0.00E+00 | −4.693E−09 | 0.00E+00 |
| M | 3.803E−15 | 0.00E+00 | 0.00E+00 | 0.00E+00 | 0.00E+00 | 0.00E+00 | 1.143E−10 | 0.00E+00 |
| N | −2.476E−17 | 0.00E+00 | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 | 0.00E+00 | 0.00E+00 |

| Value | S11 | S12 | S13 | S14 | S15 | S16 | S17 | S18 |
|---|---|---|---|---|---|---|---|---|
| K | 2.5000 | −0.1738 | 2.2697 | 2.5000 | −1.6323 | −1.6677 | −1.1302 | 2.5000 |
| A | 1.368E−02 | 7.735E−03 | −2.818E−03 | −1.988E−03 | 3.721E−02 | 1.602E−02 | −1.927E−02 | 2.874E−04 |
| B | −7.218E−03 | −4.277E−03 | −2.342E−04 | −6.252E−04 | −2.247E−02 | −5.341E−03 | 4.109E−03 | 4.222E−04 |
| C | 2.400E−03 | 1.118E−03 | 1.729E−04 | 2.445E−04 | 8.793E−03 | 8.985E−04 | −8.441E−04 | −1.795E−04 |
| D | −6.506E−04 | −8.122E−05 | −1.035E−04 | −7.711E−05 | −2.532E−03 | 4.154E−05 | 1.394E−04 | 3.372E−05 |
| E | 1.556E−04 | −8.249E−05 | 3.918E−05 | 1.550E−05 | 5.373E−04 | −6.676E−05 | −1.758E−05 | −3.886E−06 |
| F | −3.343E−05 | 4.229E−05 | −9.519E−06 | −1.525E−06 | −8.338E−05 | 1.938E−05 | 1.645E−06 | 2.732E−07 |
| G | 5.731E−06 | −1.030E−05 | 1.541E−06 | −3.485E−08 | 9.369E−06 | −3.348E−06 | −1.120E−07 | −9.481E−09 |
| H | −6.690E−07 | 1.427E−06 | −1.667E−07 | 3.028E−08 | −7.484E−07 | 3.946E−07 | 5.448E−09 | −1.449E−10 |
| J | 4.515E−08 | −1.075E−07 | 1.180E−08 | −3.910E−09 | 4.117E−08 | −3.295E−08 | −1.823E−10 | 3.466E−11 |
| L | −1.305E−09 | 3.423E−09 | −5.214E−10 | 2.496E−10 | −1.475E−09 | 1.957E−09 | 3.869E−12 | −1.897E−12 |
| M | 0.00E+00 | 0.00E+00 | 1.299E−11 | −8.150E−12 | 3.089E−11 | −8.100E−11 | −4.012E−14 | 5.790E−14 |
| N | 0.00E+00 | 0.00E+00 | −1.387E−13 | 1.083E−13 | −2.859E−13 | 2.224E−12 | −1.488E−16 | −1.061E−15 |
| O | 0.00E+00 | 0.00E+00 | 0.00E+00 | 0.00E+00 | 0.00E+00 | −3.644E−14 | 8.495E−18 | 1.095E−17 |
| P | 0.00E+00 | 0.00E+00 | 0.00E+00 | 0.00E+00 | 0.00E+00 | 2.696E−16 | −6.521E−20 | −4.912E−20 |

Referring to Table 2, the object-side surface and the image-side surface of each of the first lens 110, the second lens 120, the third lens 130, the fourth lens 140, the fifth lens 150, the sixth lens 160, the seventh lens 170, and the eighth lens 180 may all be aspherical.

### Second Embodiment

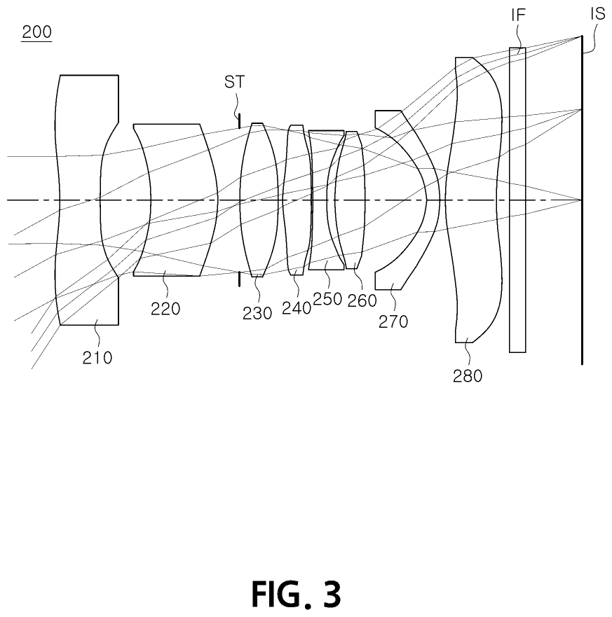

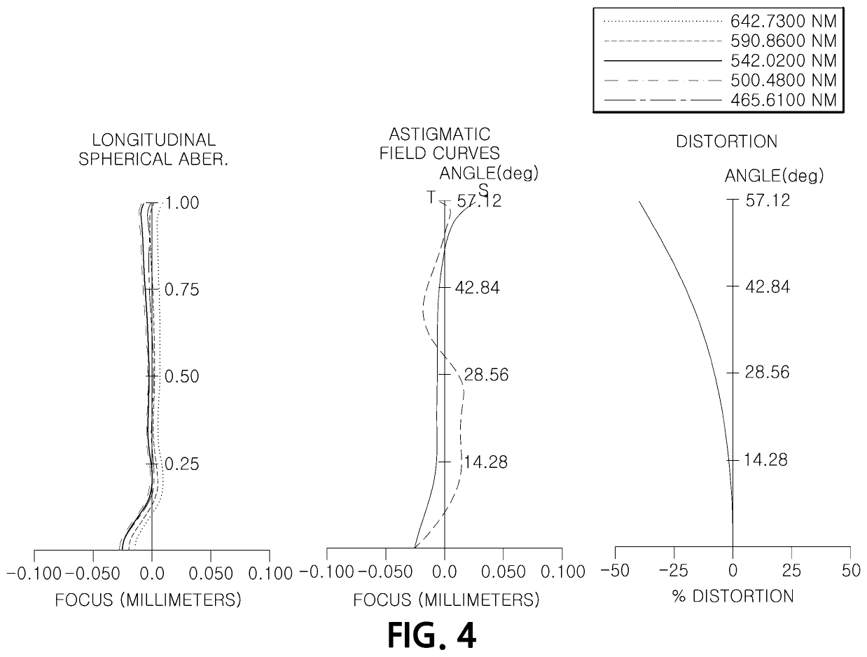

FIG. 3 is a diagram illustrating a configuration of an optical imaging system according to a second embodiment of the present disclosure, and FIG. 4 is graphs illustrating aberration characteristics of the optical imaging system illustrated in FIG. 3.

An optical imaging system 200 according to the second embodiment of the present disclosure may include a first lens 210, a second lens 220, a third lens 230, a fourth lens 240, a fifth lens 250, a sixth lens 260, a seventh lens 270, and an eighth lens 280 sequentially arranged in ascending numerical order along an optical axis of the optical imaging system 200 from an object side of the optical imaging system 200 toward an imaging plane of the optical imaging system 200.

The first lens 210 may have a negative refractive power. A focal length f1 of the first lens 210 may be −11.8001 mm. The first lens 210 may have a concave object-side surface in a paraxial region thereof, and a concave image-side surface in a paraxial region thereof. An Abbe number of the first lens 210 may be greater than 50.

The second lens 220 may have a positive refractive power. A focal length f2 of the second lens 220 may be 19.5138 mm. The second lens 220 may have a concave object-side surface in a paraxial region thereof, and a convex image-side surface in a paraxial region thereof. An Abbe number of the second lens 220 may be less than the Abbe number of the first lens 210, and may be greater than 30.

The third lens 230 may have a positive refractive power. A focal length f3 of the third lens 230 may be 24.2491 mm. The third lens 230 may have a convex object-side surface in a paraxial region thereof, and a convex image-side surface in a paraxial region thereof. An Abbe number of the third lens 230 may be greater than 50.

The fourth lens 240 may have a positive refractive power. A focal length f4 of the fourth lens 240 may be 8.1100 mm. The fourth lens 240 may have a convex object-side surface in a paraxial region thereof, and a concave image-side surface in a paraxial region thereof. An Abbe number of the fourth lens 240 may be greater than 50.

The fifth lens 250 may have a negative refractive power. A focal length f5 of the fifth lens 250 may be −6.7186 mm. The fifth lens 250 may have a concave object-side surface in a paraxial region thereof, and a concave image-side surface in a paraxial region thereof. An Abbe number of the fifth lens 250 may be less than 30.

The sixth lens 260 may have a positive refractive power. A focal length f6 of the sixth lens 260 may be 9.2626 mm. The sixth lens 260 may have a convex object-side surface in a paraxial region thereof, and a convex image-side surface in a paraxial region thereof. An Abbe number of the sixth lens 260 may be greater than 50.

The seventh lens 270 may have a negative refractive power. A focal length f7 of the seventh lens 270 may be −10.9992 mm. The seventh lens 270 may have a concave object-side surface in a paraxial region thereof, and a convex image-side surface in a paraxial region thereof. An Abbe number of the seventh lens 270 may be less than 30.

The eighth lens 280 may have a positive refractive power. A focal length f8 of the eighth lens 280 may be 21.2407 mm. The eighth lens 280 may have a convex object-side surface in a paraxial region thereof, and a concave image-side surface in a paraxial region thereof. An Abbe number of the eighth lens 280 may be greater than 50.

The optical imaging system 200 according to the second embodiment of the present disclosure may include a stop ST disposed between the second lens 220 and the third lens 230, and an optical filter IF and an image sensor IS disposed on an image side of the eighth lens 280. The imaging plane of the optical imaging system 200 may be formed on the image sensor IS.

The characteristics of each element of the optical imaging system 200 according to the second embodiment of the present disclosure are illustrated in Table 3 below.

TABLE 3

| | | | Thick- | Refrac- | | |
|---|---|---|---|---|---|---|
| Surface | | Radius of | ness/ | tive | Abbe | Effective |
| No. | Element | Curvature | Distance | Index | Number | Radius |
| Object | | Infinity | Infinity | | | |
| S1 | | Infinity | 0.000 | | | |
| S2 | First | −8.7443 | 1.5000 | 1.538 | 55.76 | 4.756 |
| S3 | Lens | 24.4529 | 1.8945 | | | 2.942 |
| S4 | Second | −7.0314 | 2.5000 | 1.571 | 37.35 | 2.500 |
| S5 | Lens | −4.8686 | 0.8084 | | | 2.638 |
| S6 | Stop | Infinity | 0.0200 | | | 2.741 |
| S7 | Third | 13.8068 | 1.4203 | 1.538 | 55.76 | 2.869 |
| S8 | Lens | −223.3941 | 0.1736 | | | 2.914 |
| S9 | Fourth | 4.0550 | 1.0557 | 1.538 | 55.76 | 2.849 |
| S10 | Lens | 53.0158 | 0.0793 | | | 2.732 |
| S11 | Fifth | −9.7918 | 0.5000 | 1.621 | 25.94 | 2.637 |
| S12 | Lens | 7.4048 | 0.3040 | | | 2.454 |
| S13 | Sixth | 6.0151 | 1.1184 | 1.538 | 55.76 | 2.484 |
| S14 | Lens | −26.9746 | 2.3043 | | | 2.603 |
| S15 | Seventh | −1.8337 | 0.5000 | 1.621 | 25.94 | 2.746 |
| S16 | Lens | −2.7690 | 0.1937 | | | 3.400 |
| S17 | Eighth | 5.3863 | 1.9086 | 1.538 | 55.76 | 5.048 |
| S18 | Lens | 8.9362 | 0.4857 | | | 5.419 |
| S19 | Filter | Infinity | 0.6059 | 1.519 | 64.17 | 5.699 |
| S20 | | Infinity | 2.0887 | | | 5.785 |
| S21 | Imaging | Infinity | | | | 6.238 |
| | Plane | | | | | |

Referring to Table 3, the second lens 220 may be the thickest lens among the first lens 210 to the eighth lens 280, and the fifth lens 250 and the seventh lens 270 may be high refractive index lenses each having a refractive index of 1.6 or higher.

Aspherical coefficients of each lens of the optical imaging system 200 according to the second embodiment of the present disclosure are illustrated in Table 4 below.

TABLE 4

| Value | S2 | S3 | S4 | S5 | S7 | S8 | S9 | S10 |
|---|---|---|---|---|---|---|---|---|
| K | −1.6812 | 39.2037 | 0.0968 | 0.2770 | 20.1988 | −27.3781 | −26.4436 | 11.5013 |
| A | 7.506E−03 | 8.716E−03 | −1.950E−03 | 5.483E−03 | 5.495E−03 | −4.630E−02 | −4.642E−03 | −1.086E−02 |
| B | −7.518E−04 | 1.186E−04 | −5.371E−04 | −6.831E−04 | −1.546E−03 | 2.432E−02 | −1.207E−02 | −5.571E−03 |
| C | 8.668E−05 | −8.449E−04 | 6.426E−04 | 3.408E−04 | 1.013E−03 | −1.238E−02 | 1.228E−02 | 8.211E−03 |
| D | −1.135E−05 | 7.123E−04 | −5.117E−04 | −1.954E−04 | −1.021E−03 | 6.072E−03 | −7.787E−03 | −7.864E−03 |
| E | 1.504E−06 | −3.842E−04 | 2.881E−04 | 9.039E−05 | 7.571E−04 | −2.607E−03 | 3.733E−03 | 5.290E−03 |
| F | −1.732E−07 | 1.437E−04 | −1.145E−04 | −2.902E−05 | −3.926E−04 | 9.075E−04 | −1.371E−03 | −2.435E−03 |
| G | 1.573E−08 | −3.825E−05 | 3.270E−05 | 6.311E−06 | 1.446E−04 | −2.466E−04 | 3.834E−04 | 7.754E−04 |
| H | −1.074E−09 | 7.336E−06 | −6.786E−06 | −8.939E−07 | −3.835E−05 | 5.128E−05 | −8.115E−05 | −1.727E−04 |
| J | 5.357E−11 | −1.015E−06 | 1.025E−06 | 7.142E−08 | 7.356E−06 | −8.035E−06 | 1.287E−05 | 2.684E−05 |
| L | −1.895E−12 | 1.003E−07 | −1.114E−07 | −7.732E−10 | −1.011E−06 | 9.293E−07 | −1.504E−06 | −2.842E−06 |
| M | 4.549E−14 | −6.896E−09 | 8.495E−09 | −4.802E−10 | 9.710E−08 | −7.678E−08 | 1.254E−07 | 1.933E−07 |
| N | −6.835E−16 | 3.127E−10 | −4.311E−10 | 5.199E−11 | −6.191E−09 | 4.282E−09 | −7.068E−09 | −7.300E−09 |
| O | 5.439E−18 | −8.391E−12 | 1.307E−11 | −2.420E−12 | 2.354E−10 | −1.442E−10 | 2.411E−10 | 8.588E−11 |
| P | −1.430E−20 | 1.008E−13 | −1.792E−13 | 4.479E−14 | −4.044E−12 | 2.214E−12 | −3.759E−12 | 1.883E−12 |

| Value | S11 | S12 | S13 | S14 | S15 | S16 | S17 | S18 |
|---|---|---|---|---|---|---|---|---|
| K | −98.2167 | 5.3167 | −2.7969 | 99.0000 | −2.1015 | −7.2833 | −7.0695 | −8.2661 |
| A | 2.972E−03 | 9.800E−03 | −7.792E−03 | 7.095E−04 | 1.415E−02 | −1.541E−02 | −1.020E−02 | −4.846E−03 |
| B | 6.933E−03 | 6.464E−03 | 7.710E−03 | −3.059E−03 | −1.232E−02 | 5.901E−03 | 2.533E−03 | 7.124E−04 |
| C | −4.859E−03 | −7.410E−03 | −8.745E−03 | 5.208E−03 | 4.807E−03 | −2.913E−03 | −5.226E−04 | −1.517E−04 |
| D | 9.817E−05 | 3.646E−03 | 8.787E−03 | −5.920E−03 | −1.455E−03 | 1.320E−03 | 8.357E−05 | 2.818E−05 |
| E | 1.458E−03 | −1.164E−03 | −6.816E−03 | 4.553E−03 | 3.653E−04 | −4.744E−04 | −1.008E−05 | −4.134E−06 |
| F | −9.556E−04 | 2.530E−04 | 3.911E−03 | −2.470E−03 | −9.935E−05 | 1.290E−04 | 9.085E−07 | 4.608E−07 |
| G | 3.314E−04 | −3.417E−05 | −1.645E−03 | 9.672E−04 | 3.165E−05 | −2.617E−05 | −6.086E−08 | −3.852E−08 |
| H | −7.234E−05 | 1.187E−06 | 5.071E−04 | −2.761E−04 | −8.955E−06 | 3.942E−06 | 3.004E−09 | 2.396E−09 |
| J | 1.025E−05 | 6.405E−07 | −1.141E−04 | 5.746E−05 | 1.855E−06 | −4.379E−07 | −1.075E−10 | −1.097E−10 |
| L | −9.092E−07 | −1.670E−07 | 1.850E−05 | −8.610E−06 | −2.646E−07 | 3.532E−08 | 2.706E−12 | 3.637E−12 |
| M | 4.296E−08 | 2.156E−08 | −2.103E−06 | 9.038E−07 | 2.521E−08 | −2.010E−09 | −4.557E−14 | −8.458E−14 |
| N | −2.678E−10 | −1.634E−09 | 1.589E−07 | −6.301E−08 | −1.525E−09 | 7.642E−11 | 4.677E−16 | 1.305E−15 |
| O | −6.766E−11 | 6.891E−11 | −7.161E−09 | 2.618E−09 | 5.277E−11 | −1.739E−12 | −2.380E−18 | −1.198E−17 |
| P | 2.196E−12 | −1.246E−12 | 1.456E−10 | −4.898E−11 | −7.928E−13 | 1.790E−14 | 2.849E−21 | 4.936E−20 |

Referring to Table 4, the object-side surface and the image-side surface of each of the first lens 210, the second lens 220, the third lens 230, the fourth lens 240, the fifth lens 250, the sixth lens 260, the seventh lens 270, and the eighth lens 280 may all be aspherical.

### Third Embodiment

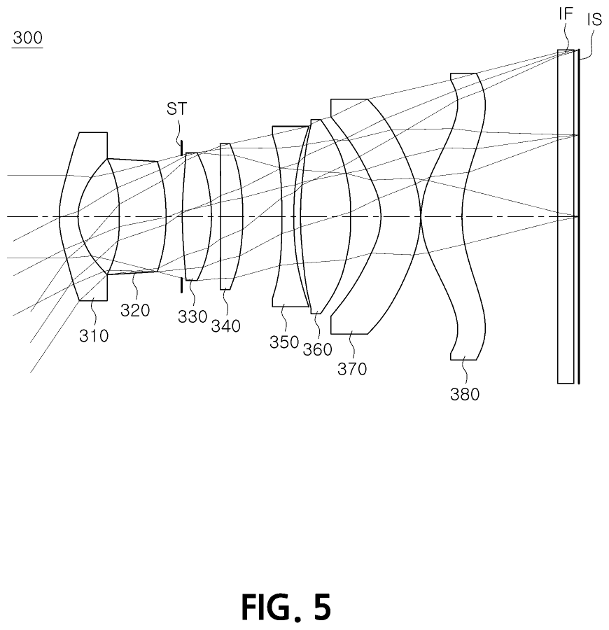

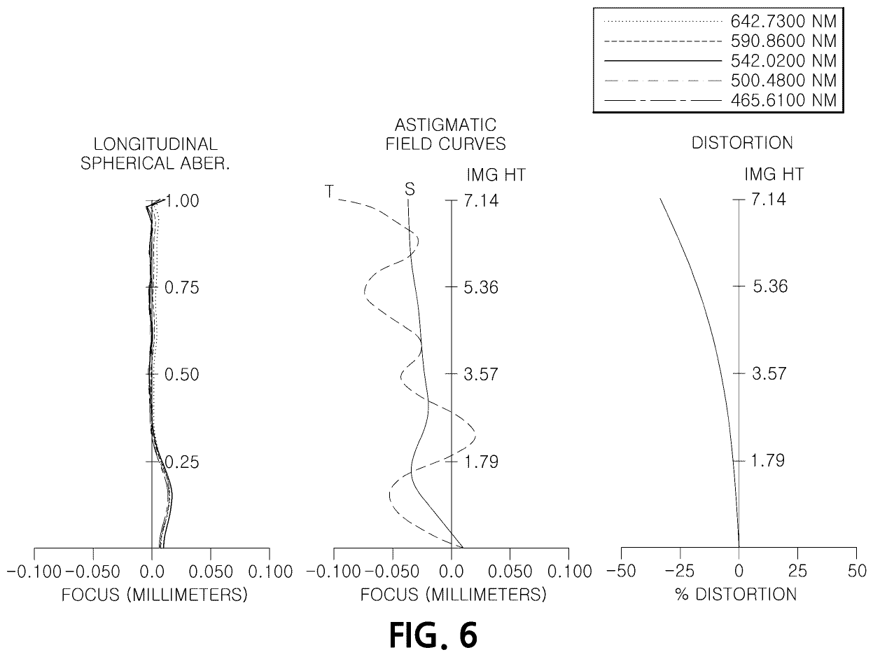

FIG. 5 is a diagram illustrating a configuration of an optical imaging system according to a third embodiment of the present disclosure, and FIG. 6 is graphs illustrating aberration characteristics of the optical imaging system illustrated in FIG. 5.

An optical imaging system 300 according to the third embodiment of the present disclosure may include a first lens 310, a second lens 320, a third lens 330, a fourth lens 340, a fifth lens 350, a sixth lens 360, a seventh lens 370, and an eighth lens 380 sequentially arranged in ascending numerical order along an optical axis of the optical imaging system 300 from an object side of the optical imaging system 300 toward an imaging plane of the optical imaging system 300.

The first lens 310 may have a negative refractive power. A focal length f1 of the first lens 310 may be −10.6284 mm. The first lens 310 may have a convex object-side surface in a paraxial region thereof, and a concave image-side surface in a paraxial region thereof. An Abbe number of the first lens 310 may be greater than 50.

The second lens 320 may have a negative refractive power. A focal length f2 of the second lens 320 may be −271.5408 mm. The second lens 320 may have a concave object-side surface in a paraxial region thereof, and a convex image-side surface in a paraxial region thereof. An Abbe number of the second lens 320 may be less than the Abbe number of the first lens 310, and may be less than 30.

The third lens 330 may have a positive refractive power. A focal length f3 of the third lens 330 may be 8.9470 mm. The third lens 330 may have a convex object-side surface in a paraxial region thereof, and a convex image-side surface in a paraxial region thereof. An Abbe number of the third lens 330 may be greater than 50.

The fourth lens 340 may have a positive refractive power. A focal length f4 of the fourth lens 340 may be 25.3952 mm. The fourth lens 340 may have a concave object-side surface in a paraxial region thereof, and a convex image-side surface in a paraxial region thereof. An Abbe number of the fourth lens 340 may be greater than 50.

The fifth lens 350 may have a negative refractive power. A focal length f5 of the fifth lens 350 may be −14.1911 mm. The fifth lens 350 may have a concave object-side surface in a paraxial region thereof, and a concave image-side surface in a paraxial region thereof. An Abbe number of the fifth lens 350 may be less than 30.

The sixth lens 360 may have a positive refractive power. A focal length f6 of the sixth lens 360 may be 11.0553 mm. The sixth lens 360 may have a convex object-side surface in a paraxial region thereof, and a convex image-side surface in a paraxial region thereof. An Abbe number of the sixth lens 360 may be greater than 50.

The seventh lens 370 may have a negative refractive power. A focal length f7 of the seventh lens 370 may be −13.0251 mm. The seventh lens 370 may have a concave object-side surface in a paraxial region thereof, and a convex image-side surface in a paraxial region thereof. An Abbe number of the seventh lens 370 may be less than 30.

The eighth lens 380 may have a positive refractive power. A focal length f8 of the eighth lens 380 may be 11.7789 mm. The eighth lens 380 may have a convex object-side surface in a paraxial region thereof, and a concave image-side surface in a paraxial region thereof. An Abbe number of the eighth lens 380 may be greater than 50.

The optical imaging system 300 according to the third embodiment of the present disclosure may include a stop ST disposed between the second lens 320 and the third lens 330, and an optical filter IF and an image sensor IS disposed on an image side of the eighth lens 380. The imaging plane of the optical imaging system 300 may be formed on the image sensor IS.

The characteristics of each element of the optical imaging system 300 according to the third embodiment of the present disclosure are illustrated in Table 5 below.

TABLE 5

| | | | Thick- | Refrac- | | |
|---|---|---|---|---|---|---|
| Surface | | Radius of | ness/ | tive | Abbe | Effective |
| No. | Element | Curvature | Distance | Index | Number | Radius |
| Object | | Infinity | Infinity | | | |
| S1 | | Infinity | 0.000 | | | |
| S2 | First | 4.6254 | 0.7862 | 1.547 | 55.99 | 3.609 |
| S3 | Lens | 2.4204 | 1.7397 | | | 2.505 |
| S4 | Second | −7.6108 | 1.9388 | 1.696 | 18.041 | 2.485 |
| S5 | Lens | −8.7593 | 0.4117 | | | 2.364 |
| S6 | Stop | Infinity | 0.2771 | | | 2.564 |
| S7 | Third | 14.9568 | 1.2262 | 1.538 | 55.76 | 2.677 |
| S8 | Lens | −7.0555 | 0.3825 | | | 2.730 |
| S9 | Fourth | −171.6687 | 0.9309 | 1.538 | 55.76 | 3.015 |
| S10 | Lens | −13.4007 | 1.6402 | | | 3.122 |
| S11 | Fifth | −38.6094 | 0.5000 | 1.621 | 25.94 | 3.503 |
| S12 | Lens | 13.3529 | 0.2888 | | | 3.870 |
| S13 | Sixth | 12.2700 | 2.0958 | 1.538 | 55.76 | 3.960 |
| S14 | Lens | −11.1875 | 1.2830 | | | 4.147 |
| S15 | Seventh | −2.3912 | 1.6501 | 1.621 | 25.94 | 4.251 |
| S16 | Lens | −4.1671 | 0.0200 | | | 5.024 |
| S17 | Eighth | 3.2759 | 1.7166 | 1.538 | 55.76 | 5.846 |
| S18 | Lens | 5.4344 | 4.0000 | | | 6.136 |
| S19 | Filter | Infinity | 0.7100 | 1.519 | 64.17 | 7.006 |
| S20 | | Infinity | 0.2023 | | | 7.124 |
| S21 | Imaging | Infinity | | | | 7.176 |
| | Plane | | | | | |

Referring to Table 5, the sixth lens 360 may be the thickest lens among the first lens 310 to the eighth lens 280, and the second lens 320, the fifth lens 350, and the seventh lens 370 may be high refractive index lenses each having a refractive index of 1.6 or higher.

Aspherical coefficients of each lens of the optical imaging system 300 according to the third embodiment of the present disclosure are illustrated in Table 6 below.

TABLE 6

| Value | S2 | S3 | S4 | S5 | S7 | S8 | S9 | S10 |
|---|---|---|---|---|---|---|---|---|
| K | −5.0290 | −1.1777 | 1.5430 | 7.7341 | −55.4920 | 1.2519 | 62.7681 | 5.8148 |
| A | 1.129E−02 | 2.779E−02 | −3.529E−03 | 1.367E−03 | −4.125E−03 | −1.615E−03 | 1.983E−03 | −6.098E−04 |
| B | −1.948E−02 | −8.918E−02 | 6.547E−03 | −6.164E−03 | 1.589E−02 | 1.236E−02 | −1.857E−03 | −4.010E−03 |
| C | 1.762E−02 | 1.613E−01 | −1.515E−02 | 9.197E−03 | −3.445E−02 | −2.238E−02 | 4.498E−03 | 5.274E−03 |
| D | −1.036E−02 | −1.919E−01 | 2.130E−02 | −6.823E−03 | 4.241E−02 | 2.397E−02 | −6.023E−03 | −4.326E−03 |
| E | 4.164E−03 | 1.574E−01 | −1.952E−02 | 1.219E−03 | −3.333E−02 | −1.726E−02 | 4.543E−03 | 2.420E−03 |
| F | −1.183E−03 | −9.163E−02 | 1.222E−02 | 2.499E−03 | 1.779E−02 | 8.693E−03 | −2.191E−03 | −9.599E−04 |
| G | 2.424E−04 | 3.853E−02 | −5.398E−03 | −2.716E−03 | −6.684E−03 | −3.130E−03 | 7.202E−04 | 2.748E−04 |
| H | −3.624E−05 | −1.180E−02 | 1.710E−03 | 1.456E−03 | 1.802E−03 | 8.151E−04 | −1.665E−04 | −5.725E−05 |
| J | 3.951E−06 | 2.631E−03 | −3.905E−04 | −4.939E−04 | −3.507E−04 | −1.537E−04 | 2.739E−05 | 8.661E−06 |
| L | −3.107E−07 | −4.216E−04 | 6.383E−05 | 1.122E−04 | 4.890E−05 | 2.076E−05 | −3.193E−06 | −9.405E−07 |
| M | 1.715E−08 | 4.726E−05 | −7.289E−06 | −1.709E−05 | −4.767E−06 | −1.958E−06 | 2.579E−07 | 7.134E−08 |
| N | −6.301E−10 | −3.515E−06 | 5.526E−07 | 1.680E−06 | 3.087E−07 | 1.224E−07 | −1.374E−08 | −3.586E−09 |
| O | 1.384E−11 | 1.556E−07 | −2.501E−08 | −9.650E−08 | −1.194E−08 | −4.559E−09 | 4.339E−10 | 1.073E−10 |
| P | −1.374E−13 | −3.103E−09 | 5.117E−10 | 2.462E−09 | 2.087E−10 | 7.653E−11 | −6.156E−12 | −1.444E−12 |

| Value | S11 | S12 | S13 | S14 | S15 | S16 | S17 | S18 |
|---|---|---|---|---|---|---|---|---|
| K | 97.7367 | 2.4521 | −17.7977 | 2.9611 | −3.9897 | −1.7044 | −3.7034 | −3.0123 |
| A | 7.553E−03 | 2.759E−03 | −2.031E−03 | −3.209E−03 | −2.313E−03 | 3.787E−03 | 9.581E−04 | −4.386E−03 |
| B | −1.959E−02 | −8.382E−03 | −9.090E−04 | 1.618E−03 | 2.006E−03 | 8.275E−04 | −4.780E−06 | 1.560E−03 |
| C | 2.158E−02 | 9.533E−03 | 1.603E−03 | −1.151E−03 | −1.160E−03 | −6.975E−04 | −3.581E−05 | −4.192E−04 |
| D | −1.427E−02 | −5.625E−03 | −8.283E−04 | 5.547E−04 | 4.199E−04 | 2.216E−04 | −1.024E−06 | 7.615E−05 |
| E | 6.254E−03 | 2.067E−03 | 2.285E−04 | −1.841E−04 | −1.076E−04 | −4.481E−05 | 2.329E−06 | −9.738E−06 |
| F | −1.921E−03 | −5.169E−04 | −3.868E−05 | 4.306E−05 | 2.079E−05 | 6.403E−06 | −5.187E−07 | 8.945E−07 |
| G | 4.264E−04 | 9.199E−05 | 4.175E−06 | −7.288E−06 | −3.141E−06 | −6.729E−07 | 6.227E−08 | −5.992E−08 |
| H | −6.928E−05 | −1.190E−05 | −2.748E−07 | 9.060E−07 | 3.738E−07 | 5.273E−08 | −4.805E−09 | 2.949E−09 |
| J | 8.246E−06 | 1.125E−06 | 8.167E−09 | −8.273E−08 | −3.432E−08 | −3.073E−09 | 2.523E−10 | −1.065E−10 |
| L | −7.108E−07 | −7.703E−08 | 2.589E−10 | 5.468E−09 | 2.339E−09 | 1.311E−10 | −9.151E−12 | 2.789E−12 |
| M | 4.316E−08 | 3.721E−09 | −3.746E−11 | −2.534E−10 | −1.128E−10 | −3.966E−12 | 2.262E−13 | −5.154E−14 |
| N | −1.749E−09 | −1.203E−10 | 1.687E−12 | 7.780E−12 | 3.601E−12 | 8.031E−14 | −3.647E−15 | 6.374E−16 |
| O | 4.244E−11 | 2.335E−12 | −3.774E−14 | −1.417E−13 | −6.795E−14 | −9.741E−16 | 3.459E−17 | −4.736E−18 |
| P | −4.659E−13 | −2.056E−14 | 3.532E−16 | 1.155E−15 | 5.718E−16 | 5.340E−18 | −1.465E−19 | 1.600E−20 |

Referring to Table 6, the object-side surface and the image-side surface of each of the first lens 310, the second lens 320, the third lens 330, the fourth lens 340, the fifth lens 350, the sixth lens 360, the seventh lens 370, and the eighth lens 380 may all be aspherical.

### Fourth Embodiment

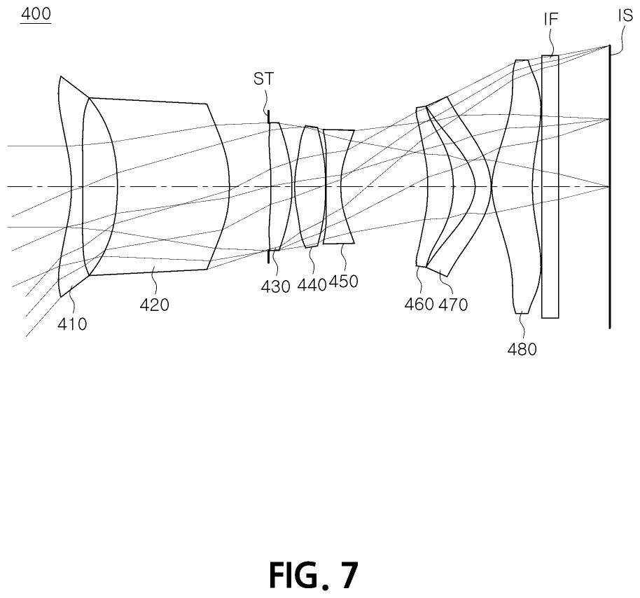

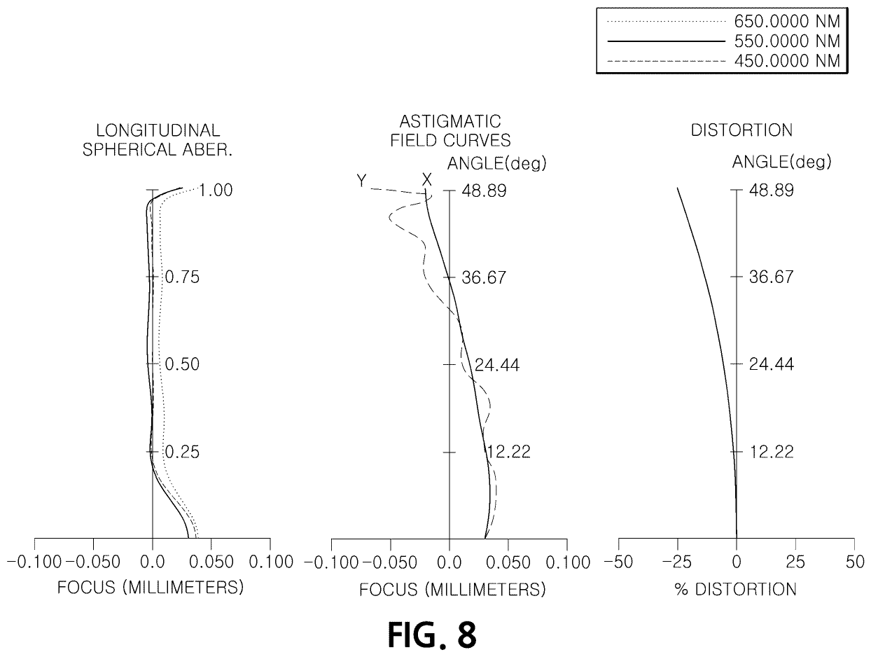

FIG. 7 is a diagram illustrating a configuration of an optical imaging system according to a fourth embodiment of the present disclosure, and FIG. 8 is graphs illustrating aberration characteristics of the optical imaging system illustrated in FIG. 7.

An optical imaging system 400 according to the fourth embodiment of the present disclosure may include a first lens 410, a second lens 420, a third lens 430, a fourth lens 440, a fifth lens 450, a sixth lens 460, a seventh lens 470, and an eighth lens 480 sequentially arranged in ascending numerical order along an optical axis of the optical imaging system 400 from an object side of the optical imaging system 400 toward an imaging plane of the optical imaging system 400.

The first lens 410 may have a negative refractive power. A focal length f1 of the first lens 410 may be −15.1675 mm. The first lens 410 may have a concave object-side surface in a paraxial region thereof, and a convex image-side surface in a paraxial region thereof. An Abbe number of the first lens 410 may be greater than 50.

The second lens 420 may have a positive refractive power. A focal length f2 of the second lens 420 may be 15.2253 mm. The second lens 420 may have a concave object-side surface in a paraxial region thereof, and a convex image-side surface in a paraxial region thereof. An Abbe number of the second lens 420 may be less than the Abbe number of the first lens 410, and may be greater than 30.

The third lens 430 may have a positive refractive power. A focal length f3 of the third lens 430 may be 29.0701 mm. The third lens 430 may have a concave object-side surface in a paraxial region thereof, and a convex image-side surface in a paraxial region thereof. An Abbe number of the third lens 430 may be greater than 50.

The fourth lens 440 may have a positive refractive power. A focal length f4 of the fourth lens 440 may be 6.9782 mm. The fourth lens 440 may have a convex object-side surface in a paraxial region thereof, and a convex image-side surface in a paraxial region thereof. An Abbe number of the fourth lens 440 may be greater than 50.

The fifth lens 450 may have a negative refractive power. A focal length f5 of the fifth lens 450 may be −6.5237 mm. The fifth lens 450 may have a concave object-side surface in a paraxial region thereof, and a concave image-side surface in a paraxial region thereof. An Abbe number of the fifth lens 450 may be less than 30.

The sixth lens 460 may have a positive refractive power. A focal length f6 of the sixth lens 460 may be 16.9170 mm. The sixth lens 460 may have a concave object-side surface in a paraxial region thereof, and a convex image-side surface in a paraxial region thereof. An Abbe number of the sixth lens 460 may be greater than 50.

The seventh lens 470 may have a negative refractive power. A focal length f7 of the seventh lens 470 may be −8.0584 mm. The seventh lens 470 may have a concave object-side surface in a paraxial region thereof, and a convex image-side surface in a paraxial region thereof. An Abbe number of the seventh lens 470 may be less than 30.

The eighth lens 480 may have a positive refractive power. A focal length f8 of the eighth lens 480 may be 7.9078 mm. The eighth lens 480 may have a convex object-side surface in a paraxial region thereof, and a concave image-side surface in a paraxial region thereof. An Abbe number of the eighth lens 480 may be greater than 50.

The optical imaging system 400 according to the fourth embodiment of the present disclosure may include a stop ST disposed between the second lens 420 and the third lens 430, and an optical filter IF and an image sensor IS disposed on an image side of the eighth lens 480. The imaging plane of the optical imaging system 400 may be formed on the image sensor IS.

The characteristics of each element of the optical imaging system 400 according to the fourth embodiment of the present disclosure are illustrated in Table 7 below.

TABLE 7

| | | | Thick- | Refrac- | | |
|---|---|---|---|---|---|---|
| Surface | | Radius of | ness/ | tive | Abbe | Effective |
| No. | Element | Curvature | Distance | Index | Number | Radius |
| Object | | Infinity | Infinity | | | |
| S1 | | Infinity | 0.400 | | | |
| S2 | First | −6.6377 | 0.5000 | 1.538 | 55.76 | 4.816 |
| S3 | Lens | −36.8572 | 1.4582 | | | 3.896 |
| S4 | Second | −10.3631 | 4.7875 | 1.571 | 37.35 | 3.875 |
| S5 | Lens | −5.5176 | 1.6822 | | | 3.610 |
| S6 | Stop | Infinity | 0.0955 | | | 2.787 |
| S7 | Third | −11.4384 | 0.8886 | 1.538 | 55.76 | 2.789 |
| S8 | Lens | −6.7797 | 0.1151 | | | 2.777 |
| S9 | Fourth | 4.8292 | 1.3175 | 1.538 | 55.76 | 2.676 |
| S10 | Lens | −15.1141 | 0.0434 | | | 2.583 |
| S11 | Fifth | −26.7678 | 0.6152 | 1.621 | 25.94 | 2.500 |
| S12 | Lens | 4.8013 | 3.7017 | | | 2.465 |
| S13 | Sixth | −9.3464 | 1.1027 | 1.538 | 55.76 | 3.448 |
| S14 | Lens | −4.7960 | 0.9360 | | | 3.513 |
| S15 | Seventh | −1.4859 | 0.6771 | 1.621 | 25.94 | 3.520 |
| S16 | Lens | −2.4845 | 0.0374 | | | 3.928 |
| S17 | Eighth | 2.8410 | 1.7179 | 1.538 | 55.76 | 5.415 |
| S18 | Lens | 6.7741 | 0.4155 | | | 5.513 |
| S19 | Filter | Infinity | 0.7100 | 1.519 | 64.17 | 5.625 |
| S20 | | Infinity | 2.1900 | | | 5.715 |
| S21 | Imaging | Infinity | | | | 6.141 |
| | Plane | | | | | |

Referring to Table 7, the second lens 420 may be the thickest lens among the first lens 410 to the eighth lens 480, and the fifth lens 450 and the seventh lens 470 may be high refractive index lenses each having a refractive index of 1.6 or higher.

Aspherical coefficients of each lens of the optical imaging system 400 according to the fourth embodiment of the present disclosure are illustrated in Table 8 below.

TABLE 8

| Value | S2 | S3 | S4 | S5 | S7 | S8 | S9 | S10 |
|---|---|---|---|---|---|---|---|---|
| K | −0.9684 | 17.3545 | 2.2968 | 0.3220 | 0.5044 | 0.0252 | −1.1706 | −7.6878 |
| A | 4.210E−03 | 2.302E−03 | −3.202E−03 | 2.284E−03 | 1.176E−02 | −3.631E−04 | −1.195E−02 | 7.709E−03 |
| B | −4.097E−04 | −3.724E−04 | 3.392E−05 | −1.899E−06 | −2.524E−03 | −3.310E−04 | −1.218E−03 | −1.690E−02 |
| C | 9.839E−05 | 1.373E−04 | 2.830E−05 | 1.187E−06 | 4.953E−04 | 2.040E−04 | 2.283E−03 | 1.134E−02 |
| D | −2.129E−05 | −3.525E−05 | −4.032E−06 | 7.612E−07 | −7.231E−05 | −2.602E−05 | −1.573E−03 | −4.586E−03 |
| E | 3.467E−06 | 6.517E−06 | 2.222E−07 | −1.254E−07 | 7.261E−06 | −2.502E−06 | 7.549E−04 | 1.208E−03 |
| F | −4.080E−07 | −8.296E−07 | 1.821E−08 | 9.833E−09 | −4.421E−07 | 1.102E−06 | −2.473E−04 | −2.089E−04 |
| G | 3.415E−08 | 7.015E−08 | −4.532E−09 | −3.590E−10 | 1.404E−08 | −1.180E−07 | 5.464E−05 | 2.299E−05 |
| H | −2.002E−09 | −3.747E−09 | 3.733E−10 | 4.602E−12 | 0.00E+00 | 4.626E−09 | −8.018E−06 | −1.461E−06 |
| J | 8.009E−11 | 1.141E−10 | −1.478E−11 | 0.00E+00 | 0.00E+00 | 0.00E+00 | 7.501E−07 | 4.098E−08 |
| L | −2.077E−12 | −1.508E−12 | 2.342E−13 | 0.00E+00 | 0.00E+00 | 0.00E+00 | −4.054E−08 | 0.00E+00 |
| M | 3.141E−14 | 0.00E+00 | 0.00E+00 | 0.00E+00 | 0.00E+00 | 0.00E+00 | 9.649E−10 | 0.00E+00 |
| N | −2.100E−16 | 0.00E+00 | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 | 0.00E+00 | 0.00E+00 |

| Value | S11 | S12 | S13 | S14 | S15 | S16 | S17 | S18 |
|---|---|---|---|---|---|---|---|---|
| K | −39.2574 | −0.4092 | −1.9960 | 0.1128 | −1.8129 | −1.5704 | −1.4944 | −5.3875 |
| A | 2.015E−02 | 9.041E−03 | −3.661E−03 | −8.115E−03 | 4.026E−02 | 1.634E−02 | −3.050E−02 | −2.632E−03 |
| B | −1.842E−02 | −4.501E−03 | 3.360E−03 | 3.636E−03 | −3.544E−02 | −1.192E−02 | 8.245E−03 | −5.242E−04 |
| C | 1.066E−02 | 1.335E−03 | −3.098E−03 | −2.390E−03 | 1.837E−02 | 5.354E−03 | −1.737E−03 | 2.939E−04 |
| D | −4.067E−03 | −5.259E−04 | 1.948E−03 | 1.275E−03 | −6.224E−03 | −1.390E−03 | 2.625E−04 | −8.024E−05 |
| E | 9.573E−04 | 1.908E−04 | −7.832E−04 | −4.093E−04 | 1.439E−03 | 1.911E−04 | −2.854E−05 | 1.378E−05 |
| F | −1.248E−04 | −5.223E−05 | 2.084E−04 | 7.821E−05 | −2.343E−04 | −3.789E−06 | 2.256E−06 | −1.609E−06 |
| G | 4.487E−06 | 1.022E−05 | −3.749E−05 | −8.308E−06 | 2.766E−05 | −3.744E−06 | −1.300E−07 | 1.332E−07 |
| H | 1.056E−06 | −1.341E−06 | 4.578E−06 | 3.165E−07 | −2.410E−06 | 8.018E−07 | 5.388E−09 | −7.965E−09 |
| J | −1.511E−07 | 1.041E−07 | −3.738E−07 | 2.882E−08 | 1.542E−07 | −9.173E−08 | −1.545E−10 | 3.463E−10 |
| L | 6.271E−09 | −3.578E−09 | 1.952E−08 | −4.179E−09 | −6.893E−09 | 6.805E−09 | 2.772E−12 | −1.085E−11 |
| M | 0.00E+00 | 0.00E+00 | −5.892E−10 | 2.005E−10 | 1.909E−10 | −3.381E−10 | −2.096E−14 | 2.387E−13 |
| N | 0.00E+00 | 0.00E+00 | 7.813E−12 | −3.559E−12 | −2.430E−12 | 1.093E−11 | −2.374E−16 | −3.502E−15 |
| O | 0.00E+00 | 0.00E+00 | 0.00E+00 | 0.00E+00 | 0.00E+00 | −2.085E−13 | 6.713E−18 | 3.074E−17 |
| P | 0.00E+00 | 0.00E+00 | 0.00E+00 | 0.00E+00 | 0.00E+00 | 1.784E−15 | −4.510E−20 | −1.222E−19 |

Referring to Table 8, the object-side surface and the image-side surface of each of the first lens 410, the second lens 420, the third lens 430, the fourth lens 440, the fifth lens 450, the sixth lens 460, the seventh lens 470, and the eighth lens 480 may all be aspherical.

Tables 9 and 10 below illustrate the optical characteristic values and conditional expression values of the first embodiment to the fourth embodiment according to the present disclosure.

TABLE 9

| Optical | First | Second | Third | Fourth |
|---|---|---|---|---|
| Characteristic | Embodiment | Embodiment | Embodiment | Embodiment |
| f1 | −13.1179 | −11.8001 | −10.6284 | −15.1675 |
| f2 | 17.5739 | 19.5138 | −271.5408 | 15.2253 |
| f3 | 13.2473 | 24.2491 | 8.9470 | 29.0701 |
| f4 | 11.6178 | 8.1100 | 25.3952 | 6.9782 |
| f5 | −7.9096 | −6.7186 | −14.1911 | −6.5237 |
| f6 | 11.3600 | 9.2626 | 11.0553 | 16.9170 |
| f7 | −5.6726 | −10.9992 | −13.0251 | −8.0584 |
| f8 | 6.3748 | 21.2407 | 11.7789 | 7.9078 |
| f | 6.9252 | 6.7071 | 7.1849 | 7.1193 |
| FOV | 97.2500 | 114.2420 | 112.4735 | 97.7700 |
| Fno | 2.0 | 2.0 | 2.0 | 1.9 |
| TTL | 22.4851 | 19.4611 | 21.7998 | 22.9915 |
| BFL | 3.3682 | 3.1803 | 4.9123 | 3.3155 |
| ImgHT | 6.1290 | 6.2347 | 7.1430 | 6.1353 |

TABLE 10

| | First | Second | Third | Fourth |
|---|---|---|---|---|
| Conditional | Embodi- | Embodi- | Embodi- | Embodi- |
| Expression | ment | ment | ment | ment |
| TTL/(2*ImgHT) | 1.8343 | 1.5607 | 1.5260 | 1.8737 |
| TTL/f | 3.2469 | 2.9016 | 3.0341 | 3.2295 |
| f3/f4 | 1.1403 | 2.9900 | 0.3523 | 4.1659 |
| f4/f5 | −1.4688 | −1.2071 | −1.7895 | −1.0697 |
| CT2/CT8 | 1.5181 | 1.3098 | 1.1294 | 2.7868 |
| v1 − v2 | 18.41 | 18.41 | 37.58 | 18.41 |

The optical imaging system according to the embodiments of the present disclosure may achieve a high close-range resolution.

While this disclosure includes specific embodiments, it will be apparent after an understanding of the disclosure of this application that various changes in form and details may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens having a negative refractive power, a second lens having a refractive power, a third lens having a positive refractive power, a fourth lens having a refractive power, a fifth lens having a refractive power, a sixth lens having a refractive power, a seventh lens having a negative refractive power, and an eighth lens having a refractive power, the first lens, the second lens, the third lens, the fourth lens, the fifth lens, the sixth lens, the seventh lens, and the eighth lens being sequentially arranged in ascending numerical order along an optical axis of the optical imaging system from an object side of the optical imaging system toward an imaging plane of the optical imaging system,
wherein the optical imaging system satisfies a conditional expression 2.5<TTL/f<3.5, where TTL is a distance along the optical axis from an object-side surface of the first lens to the imaging plane, and f is a focal length of the optical imaging system.

2. The optical imaging system of claim 1, wherein the second lens has a concave object-side surface in a paraxial region thereof.

3. The optical imaging system of claim 1, wherein the second lens has a convex image-side surface in a paraxial region thereof.

4. The optical imaging system of claim 1, wherein the sixth lens has a convex image-side surface in a paraxial region thereof.

5. The optical imaging system of claim 1, wherein the optical imaging system satisfies a conditional expression 1<CT2/CT8<3, where CT2 is a thickness of the second lens along the optical axis, and CT8 is a thickness of the eighth lens along the optical axis.

6. The optical imaging system of claim 1, wherein the optical imaging system satisfies a conditional expression 0<f3/f4<5, where f3 is a focal length of the third lens, and f4 is a focal length of the fourth lens.

7. The optical imaging system of claim 1, wherein the optical imaging system satisfies a conditional expression −2<f4/f5<0, where f4 is a focal length of the fourth lens, and f5 is a focal length of the fifth lens.

8. The optical imaging system of claim 1, wherein the second lens and the sixth lens each have a positive refractive power.

9. The optical imaging system of claim 1, wherein the second lens has a negative refractive power, and the sixth lens has a positive refractive power.

10. The optical imaging system of claim 1, wherein the fourth lens has a positive refractive power, and the fifth lens has a negative refractive power.

11. The optical imaging system of claim 1, wherein the second lens or the sixth lens has a greatest thickness along the optical axis among the first lens to the eighth lens.

12. An optical imaging system comprising:
a first lens, a second lens, a third lens, a fourth lens, a fifth lens, a sixth lens, a seventh lens, and an eighth lens sequentially arranged in ascending numerical order along an optical axis of the optical imaging system from an object side of the optical imaging system toward an imaging plane of the optical imaging system,
wherein the second lens or the sixth lens has a greatest thickness along the optical axis among the first lens to the eighth lens, and
the optical imaging system satisfies a conditional expression 2.5<TTL/f<3.5, where TTL is a distance along the optical axis from an object-side surface of the first lens to the imaging plane, and f is a focal length of the optical imaging system.

13. The optical imaging system of claim 12, wherein the optical imaging system satisfies a conditional expression 1.5≤TTL/(2*ImgHT)<2.0, where 2*ImgHT is a diagonal length of the imaging plane.

14. The optical imaging system of claim 12, wherein the optical imaging system satisfies a conditional expression 1<CT2/CT8<3, where CT2 is a thickness of the second lens along the optical axis, and CT8 is a thickness of the eighth lens along the optical axis.

15. The optical imaging system of claim 12, further comprising a stop disposed between the second lens and the third lens.

16. The optical imaging system of claim 12, wherein the third lens and the fourth lens each have a positive refractive power, and the seventh lens has a negative refractive power.

17. The optical imaging system of claim 12, wherein any one or any combination of any two or more of the second lens, the fifth lens, and the seventh lens has a greatest refractive index among the first lens to the eighth lens.
